(19) United States
(12) Patent Application Publication
(10) Pub. No.: US 2023/0261769 A1
(43) Pub. Date: Aug. 17, 2023

(54) REMOTE OPERATOR TERMINAL, MOVING BODY, AND COMMUNICATION CONTROL METHOD

(71) Applicant: Woven Planet Holdings, Inc., Tokyo (JP)

(72) Inventor: Yuki SUEHIRO, Ichikawa-shi (JP)

(73) Assignee: Woven Planet Holdings, Inc., Tokyo (JP)

(21) Appl. No.: 18/080,834

(22) Filed: Dec. 14, 2022

(30) Foreign Application Priority Data
Feb. 14, 2022 (JP) 2022-020667

(51) Int. Cl. H04B 17/309; G05D 1/00

(52) U.S. Cl. CPC H04B 17/309; G05D 1/0022

(57) ABSTRACT

A remote operator terminal communicates with a moving body being a target of a remote operation performed by a remote operator. The remote operator terminal executes a communication abnormality determination process that determines whether or not an abnormality occurs in the communication with the moving body based on a state of the communication with the moving body. When it is determined that no abnormality occurs, the remote operator terminal transmits remote operation information related to the remote operation performed by the remote operator to the moving body. On the other hand, when it is determined that the abnormality occurs, the remote operator terminal transmits information indicating a result of the communication abnormality determination process to the moving body without transmitting the remote operation information to the moving body.

### CROSS-REFERENCE TO RELATED APPLICATION

This application claims priority to Japanese Patent Application No. 2022-020667 filed on Feb. 14, 2022, the entire contents of which are incorporated by reference herein.

### BACKGROUND

### Technical Field

The present disclosure relates to a remote operation of a moving body performed by a remote operator.

### Background Art

Patent Literature 1 discloses a vehicle remote operation device for remotely, operating a vehicle. The vehicle remote operation device includes an operator operation unit outputting an operation signal for remotely operating the vehicle, and a plurality of control units receiving the operation signal output from the operator operation unit. Each control unit transmits the received operation signal to an operation information determination unit. When operation contents of the operation signals received from the plurality of control units are consistent with each other, the operation information determination unit transmits the operation signal to the vehicle. On the other hand, when the operation contents of the operation signals received from the plurality of control units are not consistent with each other, the operation information determination unit restricts transmission of the operation signal to the vehicle.

Patent Literature 2 discloses a remote management system for remotely operating an electronic device. The electronic device transmits image data of an input screen to an information processing device. The information processing device displays the image data of the input screen on its own display unit. When a network transmission speed decreases, the information processing device instructs the electronic device to reduce the amount of data. The electronic device reduces the amount of the image data of the input screen and transmits the reduced image data to the information processing device.

### LIST OF RELATED ART

Patent Literature 1: Japanese Laid-Open Patent Application No. JP-2021-061516
Patent Literature 2: Japanese Laid-Open Patent Application No. JP-2020-057160

### SUMMARY

A remote operation of a moving body (e.g., a vehicle, a robot) performed by a remote operator is considered. During the remote operation of the moving body, a communication is performed between the moving body and a remote operator terminal on the remote operator side. When a communication abnormality occurs, it is desirable to make a quick response in order to secure safety.

An object of the present disclosure is to provide a technique enabling a quick response to a communication abnormality that occurs during a remote operation of a moving body.

A first aspect is directed to a remote operator terminal that communicates with a moving body being a target of a remote operation performed by a remote operator.

The remote operator terminal includes one or more processors.

The one or more processors are configured to:

perform a communication with the moving body during the remote operation of the moving body;

execute a communication abnormality determination process that determines whether or not an abnormality occurs in the communication with the moving body based on a state of the communication with the moving body;

when it is determined that no abnormality occurs, transmit remote operation information related to the remote operation performed by the remote operator to the moving body; and

when it is determined that the abnormality occurs, transmit information indicating a result of the communication abnormality determination process to the moving body without transmitting the remote operation information to the moving body.

A second aspect is directed to a moving body being a target of a remote operation performed by a remote operator.

The moving body includes one or more processors.

The one or more processors are configured to:

perform a communication with a remote operator terminal on a side of the remote operator during the remote operation of the moving body;

execute a communication abnormality determination process that determines whether or not an abnormality occurs in the communication with the remote operator terminal based on a state of the communication with the remote operator terminal;

when it is determined that no abnormality occurs, transmit moving body information on the moving body to the remote operator terminal; and

when it is determined that the abnormality occurs, transmit information indicating a result of the communication abnormality determination process to the remote operator terminal without transmitting the moving body information to the remote operator terminal.

A third aspect is directed to a communication control method of controlling a communication between a moving body being a target of a remote operation performed by a remote operator and a remote operator terminal on a side of the remote operator.

The communication control method includes:

performing a communication between the moving body and the remote operator terminal during the remote operation of the moving body;

a communication abnormality determination process that determines whether or not an abnormality occurs in the communication based on a state of the communication;

when it is determined that no abnormality occurs, transmitting first information from a first device which is one of the moving body and the remote operator terminal to a second device which is another of the moving body and the remote operator terminal; and

when it is determined that the abnormality occurs, transmitting information indicating a result of the communication abnormality determination process from the first device to the second device without transmitting the first information.

According to the present disclosure, when it is determined that the communication abnormality occurs, the information indicating the result of the communication abnormality determination process is transmitted to the communication partner, but the information transmitted in the normal state is not transmitted. Therefore, the amount of data transmitted in the case of the abnormality detection is reduced. As a result, the information indicating the result of the communication abnormality determination process is quickly fed back to the communication partner. It is thus possible to make a quick response to the occurrence of the abnormality such as the communication abnormality.

### BRIEF DESCRIPTION OF DRAWINGS

FIG. 1 is a schematic diagram showing a configuration example of a remote operation system according to an embodiment of the present disclosure;

FIG. 2 is a conceptual diagram for explaining a comparative example.

FIG. 3 is a conceptual diagram for explaining a first example of a transmission information coordinating process in a case of abnormality detection according to an embodiment of the present disclosure;

FIG. 4 is a conceptual diagram for explaining a second example of a transmission information coordinating process in a case of abnormality detection according to an embodiment of the present disclosure;

FIG. 5 is a conceptual diagram for explaining a transmission information coordinating process in a case of a normal state according to an embodiment of the present disclosure;

FIG. 6 is a block diagram showing a configuration example of a vehicle according to an embodiment of the present disclosure;

FIG. 7 is a block diagram fix explaining an abnormality determination process and a transmission information coordinating process in a vehicle according to an embodiment of the present disclosure;

FIG. 8 is a flowchart showing an example of a communication abnormality determination process according to an embodiment of the present disclosure;

FIG. 9 is a flowchart showing an example of a communication abnormality determination process according to an embodiment of the present disclosure;

FIG. 10 is a flowchart showing an example of a vehicle abnormality determination process according to an embodiment of the present disclosure;

FIG. 11 is a block diagram showing a configuration example of a remote operator terminal according to an embodiment of the present disclosure;

FIG. 12 is a block diagram showing an abnormality determination process and a transmission information coordinating process in a remote operator terminal according to the embodiment of the present disclosure; and

FIG. 13 is a flowchart showing an example of a terminal abnormality determination process according to an embodiment of the present disclosure.

### EMBODIMENTS

Embodiments of the present disclosure will be described with reference to the accompanying drawings.

### 1. Overview of Remote Operation System

A remote operation (remote driving) of a moving body is considered. Examples of the moving body being a target of the remote operation include a vehicle; a robot, a flying object, and the like. The vehicle may be an autonomous driving vehicle or may be a vehicle driven by a driver, Examples of the robot include a logistics robot, a work robot, and the like. Examples of the flying object include an airplane, a drone, and the like.

As an example, in the following description, a case where the moving body being the target of the remote operation is a vehicle will be considered. When generalizing, “vehicle” in the following description shall be deemed to be replaced with “moving body.”

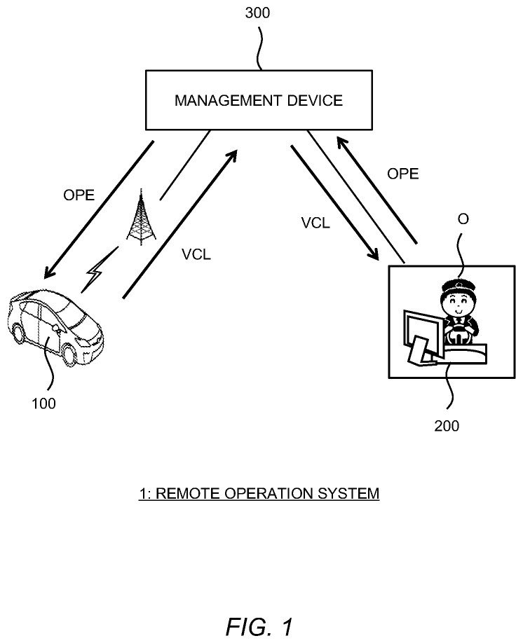

FIG. 1 is a schematic diagram showing a configuration example of a remote operation system 1 according to the present embodiment. The remote operation system 1 includes a vehicle 100, a remote operator terminal 200, and a management device 300. The vehicle 100 is the target of the remote operation. The remote operator terminal 200 is a terminal device used by a remote operator O when remotely, operating the vehicle 100. The remote operator terminal 200 can also be referred to as a remote operation human machine interface (HMI). The management device 300 manages the remote operation system 1. The management of the remote operation system 1 includes, for example, assigning a remote operator O to a vehicle 100 that requires the remote operation. The management device 300 is able to communicate with the vehicle 100 and the remote operator terminal 200 via a communication network. Typically, the management device 300 is a management server on a cloud. The management server may be configured by a plurality of servers that perform distributed processing.

Various sensors including a camera are installed on the vehicle 100. The camera images a situation around the vehicle 100 to acquire image information indicating the situation around the vehicle 100. Vehicle information VCL is information acquired by the various sensors and includes the image information captured by the camera. The vehicle 100 transmits the vehicle information VCL to the remote operator terminal 200 via the management device 300. That is, the vehicle 100 transmits the vehicle information VCL to the management device 300, and the management device 300 transfers the received vehicle information VCL to the remote operator terminal 200.

The remote operator terminal 200 receives the vehicle information VCL transmitted from the vehicle 100. The remote operator terminal 200 presents the vehicle information VCL to the remote operator O. More specifically, the remote operator terminal 200 includes a display device, and displays the image information and the like on the display device. The remote operator O views the displayed information, recognizes the situation around the vehicle 100, and performs remote operation of the vehicle 100. The remote operation information OPE is information relating to remote operation by the remote operator O. For example, the remote operation information OPE includes an amount of operation performed by the remote operator O. The remote operator terminal 200 transmits the remote operation information OPE to the vehicle 100 via the management device 300. That is, the remote operator terminal 200 transmits the remote operation information OPE to the management device 300, and the management device 300 transfers the received remote operation information OPE to the vehicle 100.

The vehicle 100 receives the remote operation information OPE transmitted from the remote operator terminal 200. The vehicle 100 performs vehicle travel control in accordance with the received remote operation information OPE. In this manner, the remote operation of the vehicle 100 is realized.

### 2. Abnormality Determination Process and Transmission Information Coordinating Process

Each of the vehicle 100 and the remote operator terminal 200 has an “abnormality determination function (abnormality detection function)” that determines whether or not an abnormality occurs during the remote operation.

For example, the vehicle 100 has a “communication abnormality determination function” that determines whether or not a communication abnormality occurs. More specifically, the vehicle 100 communicates with the remote operator terminal 200 to receive information such as the remote operation information OPE from the remote operator terminal 200. Based on the received information, it is possible to grasp a state of the communication with the remote operator terminal 200. Based on the communication state, the vehicle 100 determines whether or not an abnormality occurs in the communication from the remote operator terminal 200 to the vehicle 100.

In addition, the vehicle 100 may have a “vehicle abnormality determination function” that determines whether or not an abnormality occurs in the vehicle 100 itself.

An abnormality flag FL1 is information indicating a result of the determination by the abnormality determination function of the vehicle 100. When it is determined that no abnormality occurs, that is, when no abnormality is detected, the abnormality flag FL1 is set to “0” for example. On the other hand, when it is determined that an abnormality occurs, that is, when an abnormality is detected, the abnormality flag FL1 is set to “1” for example.

Similarly, the remote operator terminal 200 has a “communication abnormality determination function” that determines whether or not a communication abnormality occurs. More specifically, the remote operator terminal 200 communicates with the vehicle 100 to receive information such as the vehicle information VCL, from the vehicle 100. Based on the received information, it is possible to grasp a state of the communication with the vehicle 100. Based on the communication state, the remote operator terminal 200 determines whether or not an abnormality occurs in the communication from the vehicle 100 to the remote operator terminal 200.

In addition, the remote operator terminal 200 may include a “terminal abnormality determination function” that determines whether or not an abnormality occurs in the remote operator terminal 200 itself.

An abnormality flag FL2 is information indicating a result of the determination by the abnormality determination function of the remote operator terminal 200. When it is determined that no abnormality occurs, that is, when no abnormality is detected, the abnormality flag FL2 is set to “0” for example. On the other hand, when it is determined that an abnormality occurs, that is, when an abnormality is detected, the abnormality flag FL2 is set to “1” for example.

When the abnormality such as the communication abnormality occurs during the remote operation of the vehicle 100, it is desirable to make a quick response in order to secure safety. For this purpose, it is desirable to quickly feed back the abnormality detection (i.e., the abnormality flags FL1 and FL2) each to the communication partner.

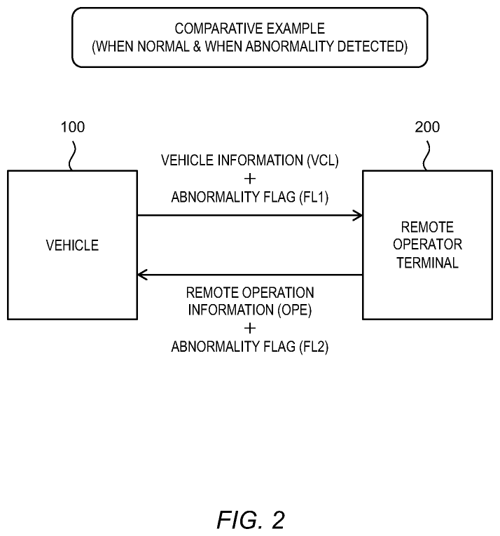

FIG. 2 is a conceptual diagram for explaining a comparative example. In the case of the comparative example, the vehicle 100 always transmits the vehicle information VCL and the abnormality flag FL1 to the remote operator terminal 200. That is, the vehicle 100 transmits the vehicle information VCL and the abnormality flag FL1 to the remote operator terminal 200 regardless of presence or absence of the abnormality detection by the abnormality determination function of the vehicle 100. Similarly, the remote operator terminal 200 always transmits the remote operation information OPE and the abnormality flag FL2 to the vehicle 100. That is, the remote operator terminal 200 transmits the remote operation information OPE and the abnormality flag FL2 to the vehicle 100 regardless of presence or absence of the abnormality detection by the abnormality determination function of the remote operator terminal 200.

As described above, according to the comparative example, a type of transmission information is the same regardless of a situation (i.e., presence or absence of the abnormality detection). However, transmitting an unnecessarily large amount of information causes an unnecessary communication delay. In particular, in the case of the abnormality detection as described above, it is desirable to quickly feed back the abnormality flags FL1 and FL2 each to the communication partner, but the unnecessary communication delay prevents the quick feedback. Therefore, according to the present embodiment, a. “transmission information coordinating process” as described below is performed.

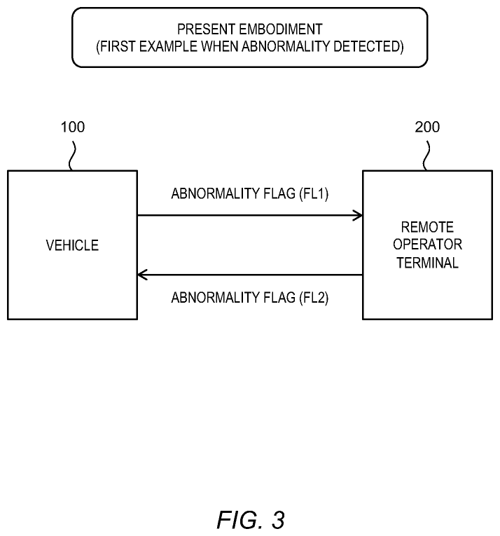

FIG. 3 is a conceptual diagram for explaining a first example of the transmission information coordinating process in the case of the abnormality detection. When the abnormality is detected by the abnormality determination function of the vehicle 100, the vehicle 100 transmits only the abnormality flag ELI to the remote operator terminal 200 without transmitting the vehicle information VCL. Similarly, when the abnormality is detected by the abnormality determination function of the remote operator device 200, the remote operator device 200 transmits only the abnormality flag FL2 to the vehicle 100 without transmitting the remote operation information OPE.

In this manner, the transmission information coordinating process reduces an amount of data transmitted in the case of the abnormality detection. As a result, the abnormality flags FL1 and FL2 each is quickly fed back to the communication partner. Even in a situation where the abnormality occurs in the communication between the vehicle 100 and the remote operator terminal 200, the abnormality flags FL1 and FL2 each is fed back to the communication partner as quickly as possible. It is thus possible to make a quick response to the occurrence of the abnormality such as the communication abnormality. For example, the vehicle 100 is able to perform evacuation control at an earlier timing. The evacuation control is control for making the vehicle 100 evacuate and stop at a safe position. Moreover, the remote operator O is able to instruct the vehicle 100 to execute the evacuation control at an earlier timing. As a result, safety is improved.

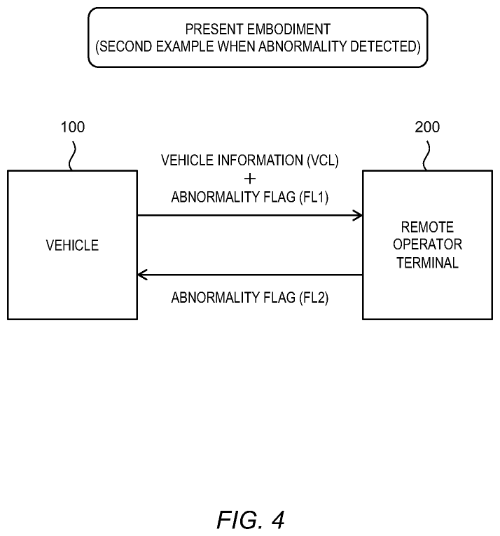

FIG. 4 is a conceptual diagram for explaining a second example of the transmission information coordinating process in the case of the abnormality detection. When the abnormality is detected by the abnormality determination function of the remote operator device 200, the remote operator device 200 transmits only the abnormality flag FL2 to the vehicle 100 without transmitting the remote operation information OPE. As a result, at least the same effect as in the case of the first example can be obtained. On the other hand, when the abnormality is detected by the abnormality determination function of the vehicle 100, the vehicle 100 transmits the vehicle information VCL and the abnormality flag FL1 to the remote operator terminal 200. Accordingly, the remote operator O is able to grasp the state of the vehicle 100 in which the abnormality may have occurred.

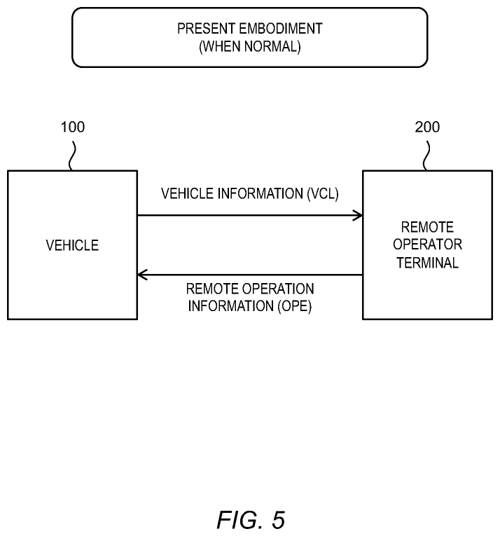

FIG. 5 is a conceptual diagram for explaining the transmission information coordinating process in a normal state. When no abnormality is detected, the vehicle 100 transmits the vehicle information VCL to the remote operator terminal 200. At this time, the vehicle 100 may not transmit the abnormality flag ELI to the remote operator terminal 200. Similarly, the remote operator terminal 200 transmit the remote operation information OPE to the vehicle 100. At this time, the remote operator terminal 200 may not transmit the abnormality flag FL2 to the vehicle 100. Refrainina from transmitting the abnormality flags FL1 and FL2 in the normal state makes it possible to reduce transmission data amount and communication costs.

As described above, according to the present embodiment, the transmission information coordinating process can suppress unnecessary information transmission during the remote operation. As a result, an unnecessary communication delay is suppressed and communication costs also are reduced. Furthermore, it is possible to make a quick response to the occurrence of the abnormality such as the communication abnormality. Thus, a more secure remote operation system 1 is achieved.

Hereinafter, the remote operation system 1 according to the present embodiment will be described in more detail.

### 3. EXAMPLE OF VEHICLE

### 3-1. Configuration Example

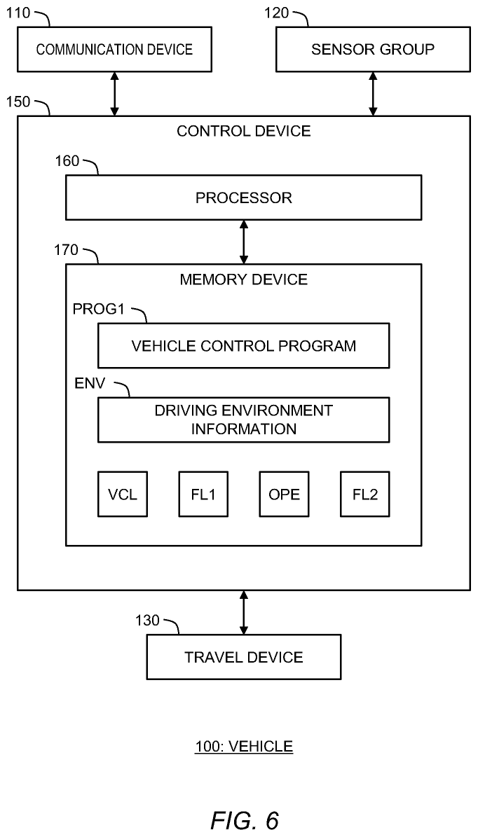

FIG. 6 is a block diagram showing a configuration example of the vehicle 100. The vehicle 100 includes a communication device 110, a sensor group 120, a travel device 130, and a control device (controller) 150.

The communication device 110 communicates with the outside of the vehicle 100. For example, the communication device 110 communicates with the remote operator terminal 200 and the management device 300.

The sensor group 120 includes a recognition sensor, a vehicle state sensor, a position sensor, and the like. The recognition sensor recognizes (detects) a situation around the vehicle 100. Examples of the recognition sensor include the camera, a laser imaging detection and ranging (LIDAR), a radar, and the like. The vehicle state sensor detects a state of the vehicle 100. Examples of the vehicle state sensor include a speed sensor, an acceleration sensor, a yaw rate sensor, a steering angle sensor, and the like. The position sensor detects a position and an orientation of the vehicle 100, For example, the position sensor includes a global navigation satellite system (GNSS).

The travel device 130 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device 150 is a computer that controls the vehicle 100. The control device 150 includes one or more processors 160 (hereinafter simply referred to as a processor 160) and one or more memory devices 170 (hereinafter simply referred to as a memory device 170). The processor 160 executes a variety of processing. For example, the processor 160 includes a central processing unit (CPU). The memory device 170 stores a variety of information necessary for the processing by the processor 160. Examples of the memory device 170 include a volatile memory, anon-volatile memory, a hard disk drive (HDD), a solid state drive (SSD), and the like. The control device 150 may include one or more electronic control units (ECUs).

A vehicle control program PROG1 is a computer program executed by the processor 160. The functions of the control device 150 are implemented by the processor 160 executing the vehicle control program PROG1. The vehicle control program PROG1 is stored in the memory device 170. The vehicle control program PROG1 may be recorded on a non-transitory computer-readable recording medium.

### 3-2. Driving Environment Information

The control device 150 uses the sensor group 120 to acquire driving environment information ENV indicating a driving environment for the vehicle 100. The driving environment information ENV is stored in the memory device 170.

The driving environment information ENV includes surrounding situation information indicating a result of recognition by the recognition sensor. For example, the surrounding situation information includes the image information captured by the camera. The surrounding situation information further includes object information regarding an object around the vehicle 100. Examples of the object around the vehicle 100 include a pedestrian, another vehicle (e.g., a preceding vehicle, a parked vehicle, etc.), a white line, a traffic signal, a sign, a roadside structure, and the like. The object information indicates a relative position and a relative velocity of the object with respect to the vehicle 100.

In addition, the driving environment information ENV includes vehicle state information indicating the vehicle state detected by the vehicle state sensor.

Furthermore, the driving environment information ENV includes vehicle position information indicating the position and the orientation of the vehicle 100. The vehicle position information is acquired by the position sensor. Highly accurate vehicle position information may be acquired by performing a well-known localization using map information and the surrounding situation information (the object information).

### 3-3. Vehicle Travel Control

The control device 150 executes vehicle travel control that controls travel of the vehicle 100. The vehicle travel control includes steering control, driving control, and braking control. The control device 150 executes the vehicle travel control by controlling the travel device 130 (i.e., the steering device, the driving device, and the braking device).

The control device 150 may execute autonomous driving control based on the driving environment information ENV. More specifically, the control device 150 generates a travel plan of the vehicle 100 based on the driving environment information ENV. Further, the control device 150 generates, based on the driving environment information ENV, a target trajectory required for the vehicle 100 to travel in accordance with the travel plan. The target trajectory includes a target position and a target speed. Then, the control device 150 executes the vehicle travel control such that the vehicle 100 follows the target trajectory.

### 3-4. Processing Related to Remote Operation

Hereinafter, the case where the remote operation of the vehicle 100 is performed will be described. The control device 150 communicates with the remote operator terminal 200 via the communication device 110.

The control device 150 transmits the vehicle information VCL: to the remote operator terminal 200. The vehicle information VCL is information necessary for the remote operation by, the remote operator O, and includes at least a part of the driving environment information ENV described above. For example, the vehicle information VCL includes the surrounding situation information (especially, the image information). The vehicle information VCL may further include the vehicle state information and the vehicle position information.

In addition, the control device 150 receives the remote operation information OPE from the remote operator terminal 200. The remote operation information OPE is information regarding the remote operation by the remote operator O. For example, the remote operation information OPE includes an amount of operation performed by the remote operator O. The control device 150 performs the vehicle travel control in accordance with the received remote operation information OPE.

### 3-4-1. Abnormality Determination Process and Transmission Information Coordinating Process

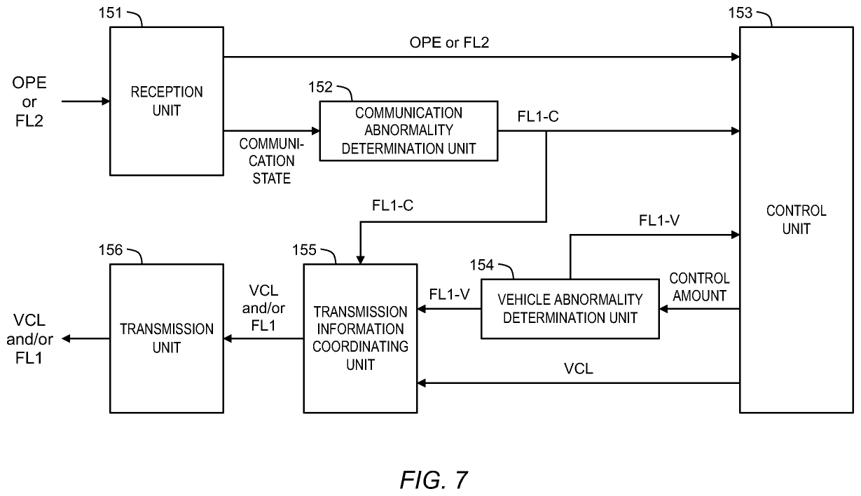

FIG. 7 is a block diagram showing an abnormality determination process and the transmission information coordinating process in the vehicle 100. The vehicle 100 includes, as functional blocks, a reception unit 151, a communication abnormality determination unit 152, a control unit 153, a vehicle abnormality determination unit 154, a transmission information coordinating unit 155, and a transmission unit 156, These functional blocks are realized by the communication device 110 and the control device 150.

The reception unit 151 receives information transmitted from the remote operator terminal 200 during the remote operation of the vehicle 100. The information transmitted from the remote operator terminal 200 includes the remote operation information OPE and the abnormality flag FL2 described above. The reception unit 151 grasps a state of the communication with the remote operator terminal 200 based on the received information. Examples of the communication state include presence or absence of data reception, a delay amount, a transmission speed, a radio wave reception intensity, and the like.

The communication abnormality determination unit 152 performs a “communication abnormality determination process.” More specifically, the communication abnormality determination unit 152 acquires information on the communication state from the reception unit 151. Then, the communication abnormality determination unit 152 determines, based on the communication state, whether or not an abnormality occurs in the communication from the remote operator terminal 200 to the vehicle 100. A specific example of the communication abnormality determination process will be described later see Section 3-4-2).

A communication abnormality flag FL1-C is the abnormality flag FL1 indicating a result of the communication abnormality determination process. When it is determined that no communication abnormality occurs, that is, when no communication abnormality is detected, the communication abnormality flag FL1-C is set to, for example, “0,” On the other hand, when it is determined that a communication abnormality occurs, that is, when a communication abnormality is detected, the communication abnormality flag FL1-C is set to, for example, “1.” The communication abnormality determination unit 152 outputs the communication abnormality flag FL1-C.

The control unit 153 receives the remote operation information OPE and the abnormality flags (RA and FL2). The control unit 153 performs the vehicle travel control in accordance with the remote operation information OPE. Moreover, the control unit 153 outputs the vehicle information VCL. Further, when the abnormality flag (FL1, FL2) indicates the abnormality detection, the control unit 153 performs a predetermined abnormality handling process. For example, the control unit 153 performs the evacuation control that makes the vehicle 100 evacuate and stop at a safe position.

The vehicle abnormality determination unit 154 performs a “vehicle abnormality determination process.” More specifically, the vehicle abnormality determination unit 154 receives information on a vehicle travel control amount calculated by the control unit 153. Then, the vehicle abnormality determination unit 154 determines, based on the vehicle travel control amount, whether or not an abnormality occurs in the vehicle travel control. A specific example of the vehicle abnormality determination process will be described later (see Section 3-4-3).

A vehicle abnormality flag FL1-V is the abnormality flag FL1 indicating a result of the vehicle abnormality determination process. When it is determined that no vehicle abnormality occurs, that is, when the vehicle abnormality is not detected, the vehicle abnormality flag FL1-V is set to, for example. “0.” On the other hand, when it is determined that a vehicle abnormality occurs, that is, when a vehicle abnormality is detected, the vehicle abnormality flag FL1-V is set to, for example, “1.” The vehicle abnormality determination unit 154 outputs the vehicle abnormality flag FL1-V.

The transmission information coordinating unit 155 performs the “transmission information coordinating process” that coordinates transmission information to be transmitted to the remote operator terminal 200. More specifically, the transmission information coordinating unit 155 receives the vehicle information VCL and the abnormality flag FL1 (FL1-C, FL1-V). Then, the transmission information coordinating unit 155 coordinates the transmission information according to a content of the abnormality flag FL1.

For example, in the normal state, the transmission information coordinating unit 155 selects the vehicle information VCL as the transmission information and excludes the abnormality flag FLA from the transmission information (see FIG. 5).

As another example, in the case of the abnormality detection, the transmission information coordinating unit 155 selects the abnormality flag FL1 as the transmission information and excludes the vehicle information VCL from the transmission information (see FIG. 3), Alternatively, in the case of the abnormality detection, the transmission information coordinating unit 155 may select both the vehicle information VCL and the abnormality flag FL1 as the transmission information (see FIG. 4).

The transmission unit 156 transmits the transmission information selected by the transmission information coordinating unit 155 to the remote operator terminal 200.

### 3-4-2. Example of Communication Abnormality Determination Process

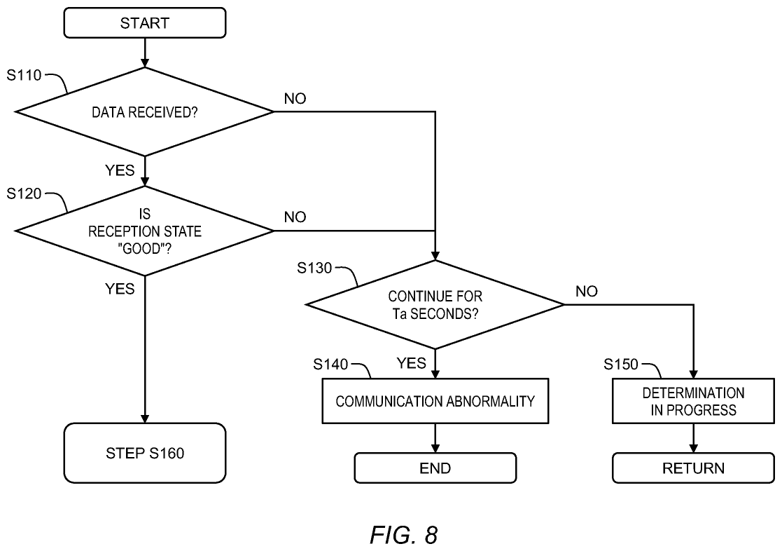

FIG. 8 is a flowchart showing an example of the communication abnormality determination process performed by the communication abnormality determination unit 152.

In Step S110, the communication abnormality determination unit 152 determines whether or not the reception unit 151 receives data. When the reception unit 151 receives data (Step S110; Yes), the processing proceeds to Step S120. Otherwise (Step S110; No), the processing proceeds to Step S130.

In Step S120, the communication abnormality determination unit 152 determines whether a reception state is good or not. The reception state is represented by a parameter such as the transmission speed, the radio wave reception intensity, and the like. When the parameter is equal to or greater than a predetermined threshold (Step S120; Yes), it is determined that the reception state is good, and the processing proceeds to Step S160. Otherwise (Step S120; No), the processing proceeds to Step S130.

In Step S130, the communication abnormality determination unit 152 determines whether or not the non-data reception state or the not-good reception state continues for Ta seconds. When such the bad state continues for Ta seconds (Step S130; Yes), the processing proceeds to Step S140. On the other hand, when such the bad state has not yet continued for Ta seconds (Step S130; No), the processing proceeds to Step S150.

In Step S140, the communication abnormality determination unit 152 determines (asserts) that the communication abnormality occurs.

In Step S150, the communication abnormality determination unit 152 sets a current state to “communication abnormality determination in progress” without confirming the determination. After that, the processing returns to Step S110.

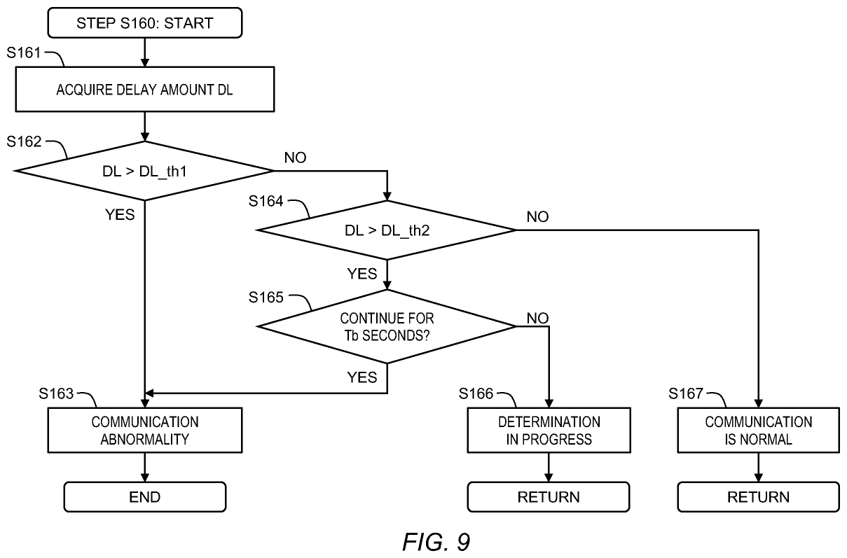

FIG. 9 is a flowchart showing an example of Step S160. In Step S160, a delay amount DL of the communication is taken into consideration.

In Step S161, the communication abnormality determination unit 152 acquires information on the delay amount DL of the communication from the reception unit 151.

In Step S162, the communication abnormality determination unit 152 determines whether or not the delay amount DL, exceeds a first threshold value DL_th1. The first threshold value DL_th1 is a delay amount DL where it can be determined that the communication abnormality occurs. For example, the first threshold value DL_th1 is a delay amount DL that cannot normally occur. When the delay amount DL exceeds the first threshold value DL_th1 (Step S162; Yes), the processing proceeds to Step S163. On the other hand, when the delay amount DL is equal to or less than the first threshold value DL_th1 (Step S162; No), the processing proceeds to Step S164.

In Step S163 the communication abnormality determination unit 152 determines (asserts) that the communication abnormality occurs.

In Step S164, the communication abnormality determination unit 152 determines whether or not the delay amount DL exceeds a second threshold value DL_th2. The second threshold value DL_th2 is smaller than the first threshold value DL_th1 described above. For example, the second threshold value DL_th2 is an upper limit value of an allowable range of the delay amount DL. When the delay amount DL exceeds the second threshold value DL_th2 (Step S164, Yes), the processing proceeds to Step S165. On the other hand, when the delay amount DL is equal to or less than the second threshold value DL_th2 (Step S164; No), the processing proceeds to Step S167.

In Step S165, the communication abnormality determination unit 152 determines whether or not the state in which the delay amount DL exceeds the second threshold value DL_th2 continues for Tb seconds. When such the state continues for Tb seconds (Step S165; Yes), the processing proceeds to Step S163. On the other hand, when such the state has not yet continued for Tb seconds (Step S165; No), the processing proceeds to Step S166.

In Step S166, the communication abnormality determination unit 152 sets the current state to “communication abnormality determination in progress” without confirming the determination. After that, the processing returns to Step S110.

In Step S167, the communication abnormality determination unit 152 determines that no communication abnormality occurs and the communication is normal. After that, the processing returns to Step S110.

### 3-4-3. Example of Vehicle Abnormality Determination Process

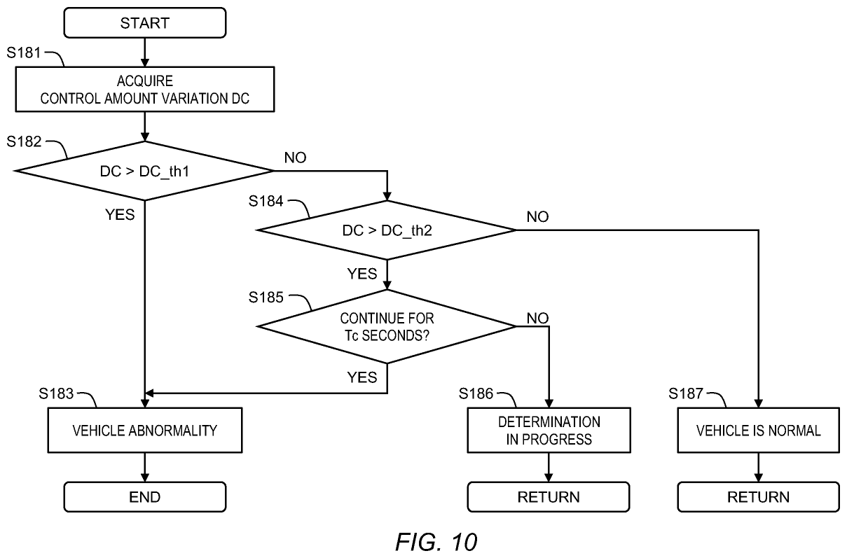

FIG. 10 is a flowchart showing an example of the vehicle abnormality determination process performed by the vehicle abnormality determination unit 154.

In Step S181, the vehicle abnormality determination unit 154 receives information on the vehicle travel control amount calculated by the control unit 153. Then, the vehicle abnormality determination unit 154 acquires a “control amount variation DC” that is a variation from a previous value of the vehicle travel control amount.

In Step S182, the vehicle abnormality determination unit 154 determines whether or not the control amount variation DC exceeds a first threshold value DC_th1. The first threshold value DC_th1 is a control amount variation DC where it can be determined that the vehicle abnormality occurs. For example, the first threshold value DC_th1 is a control amount variation DC that cannot normally occur. When the control amount variation DC exceeds the first threshold value DC_th1 (Step S182; Yes), the processing proceeds to Step S183. On the other hand, when the control amount variation DC is equal to or less than the first threshold value DC till (Step S182; No), the processing proceeds to Step S184.

In Step S183, the vehicle abnormality determination unit 154 determines (asserts) that the vehicle abnormality occurs.

In Step S184, the vehicle abnormality determination unit 154 determines whether or not the control amount variation DC exceeds a second threshold value DC_th2. The second threshold value DC_th2 is smaller than the first threshold value DC_th1 described above. For example, the second threshold value DC_th2 is an upper limit value of an allowable range of the control amount variation DC. When the control amount variation DC exceeds the second threshold value DC_th2 (Step S184; Yes), the processing proceeds to Step S185. On the other hand, when the control amount variation DC is equal to or less than the second threshold value DC_th2 (Step S184; No), the processing proceeds to Step S187.

In Step S185, the vehicle abnormality determination unit 154 determines whether or not the state in which the control amount variation DC exceeds the second threshold value DC_th2 continues for Tc seconds. When such the state continues for Tc seconds (Step S185; Yes), the processing proceeds to Step S183. On the other hand, when such the state has not yet continued for Tc seconds (Step S185; No), the processing proceeds to Step S186.

In Step S186, the vehicle abnormality determination unit 154 sets the current state to “vehicle abnormality determination in progress” without confirming the determination. After that, the processing returns to Step S181.

In Step S187, the vehicle abnormality determination unit 154 determines that no vehicle abnormality occurs and the vehicle 100 is normal. After that, the processing returns to Step S181.

### EXAMPLES OF REMOTE OPERATOR TERMINAL

### 4-1. Configuration Example

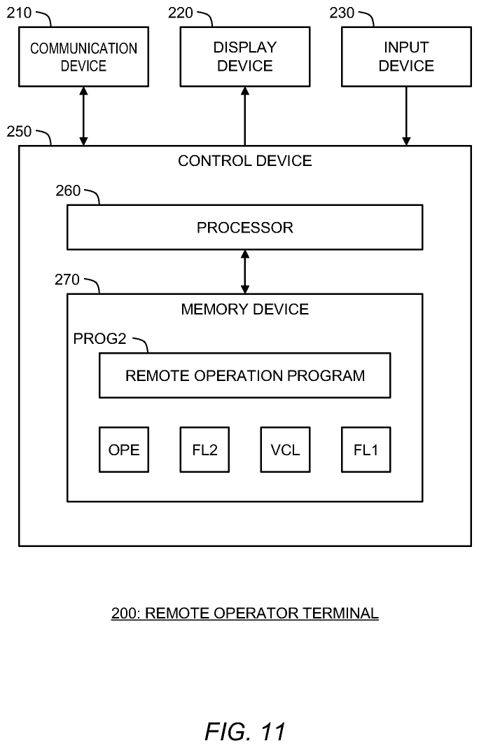

FIG. 11 is a block diagram showing a configuration example of the remote operator terminal 200. The remote operator terminal 200 includes a communications device 210, a display 220, an input device 230, and a control device (controller) 250.

The communication device 210 communicates with the vehicle 100 and the management device 300.

The display device 220 presents a variety of information to the remote operator O by displaying the variety of information.

The input device 230 receives an input from the remote operator O. For example, the input device 230 includes a remote operation member that is operated by the remote operator O when remotely operating the vehicle 100. The remote operation member includes a steering wheel, an accelerator pedal, a brake pedal, a direction indicator, and the like.

The control device 250 controls the remote operator terminal 200. The control device 250 includes one or more processors 260 (hereinafter simply referred to as a processor 260) and one or more memory devices 270 (hereinafter simply referred to as a memory device 270). The processor 260 executes a variety of processing. For example, the processor 260 includes a CPU. The memory device 270 stores a variety of information necessary for the processing by the processor 260. Examples of the memory device 270 include a volatile memory, a non-volatile memory, an HDD, an SSD, and the like.

A remote operation program PROG2 is a computer program executed by the processor 260. The functions of the control device 250 are implemented by the processor 260 executing the remote operation program PROG2. The remote operation program PROG2 is stored in the memory device 270. The remote operation program PROG2 may be recorded on a non-transitory computer-readable recording medium. The remote operation program PROG2 may be provided via a network.

The control device 250 communicates with the vehicle 100 via the communication device 210. The control device 250 receives the vehicle information VCL transmitted from the vehicle 100. The control device 250 presents the vehicle information VCL to the remote operator O by displaying the vehicle information VCL including the image information on the display device. The remote operator O is able to recognize the state of the vehicle 100 and the situation around the vehicle 100 based on the vehicle information VCL displayed on the display device.

The remote operator O operates the remote operation member of the input device 230. An operation amount of the remote operation member is detected by a sensor installed on the remote operation member. The control device 250 generates the remote operation information OPE reflecting the operation amount of the remote operation member operated by the remote operator O. Then, the control device 250 transmits the remote operation information OPE to the vehicle 100 via the communication device 210.

### 4-2. Abnormality Determination Process and Transmission Information Coordinating Process

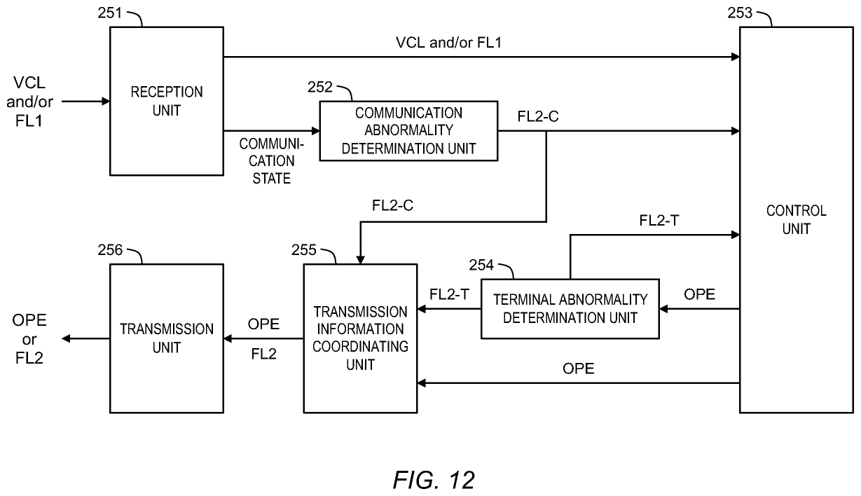

FIG. 12 is a block diagram showing an abnormality determination process and the transmission information coordinating process in the remote operator terminal 200. The remote operator terminal 200 includes, as functional blocks, a reception unit 251, a communication abnormality determination unit 252, a control unit 253, a terminal abnormality determination unit 254, a transmission information coordinating unit 255, and a transmission unit 256. These functional blocks are realized by the communication device 210 and the control device 250.

The reception unit 251 receives information transmitted from the vehicle 100 during the remote operation of the vehicle 100. The information transmitted from the vehicle 100 includes the vehicle information VCL and the abnormality flag FL1 described above. The reception unit 251 grasps a state of the communication with the vehicle 100 based on the received information. Examples of the communication state include presence or absence of data reception, a delay amount, a transmission speed, a radio wave reception intensity, and the like.

The communication abnormality determination unit 252 performs a “communication abnormality determination process.” More specifically, the communication abnormality determination unit 252 acquires information on the communication state from the reception unit 251. Then, the communication abnormality determination unit 252 determines, based on the communication state, whether or not an abnormality occurs in the communication from the vehicle 100 to the remote operator terminal 200. A specific example of the communication abnormality determination process is the same as that shown in FIGS. 8 and 9 described above.

A communication abnormality flag FL2-C is the abnormality flag FL2 indicating a result of the communication abnormality determination process. When it is determined that no communication abnormality occurs, that is, when no communication abnormality is detected, the communication abnormality flag FL2-C is set to, for example, “0.” On the other hand, when it is determined that a communication abnormality occurs, that is, when a communication abnormality is detected, the communication abnormality flag FL2-C is set to, for example, “1.” The communication abnormality determination unit 252 outputs the communication abnormality flag FL2-C.

The control unit 253 receives the vehicle information VCL and the abnormality flags (FL1, FL2). The control unit 253 presents the vehicle information VCL to the remote operator O. Moreover, the control unit 253 outputs the remote operation information OPE. Further, when the abnormality flag (RA, FL2) indicates the abnormality detection, the control unit 253 performs a predetermined abnormality handling process. For example, the control unit 253 notifies the remote operator O of the occurrence of the abnormality. The remote operator O is able to immediately instruct the vehicle 100 to perform the evacuation control.

The terminal abnormality determination unit 254 performs a “terminal abnormality determination process.” More specifically, the terminal abnormality determination unit 254 receives the remote operation information OPE output from the control unit 253. Then, the terminal abnormality determination unit 254 determines, based on the remote operation information OPE, whether or not an abnormality occurs in the remote operator terminal 200. A specific example of the terminal abnormality determination process will be described later (see Section 4-3).

A terminal abnormality flag FL2-T is the abnormality flag FL2 indicating a result of the terminal abnormality determination process. When it is determined that no terminal abnormality occurs, that is, when the terminal abnormality is not detected, the abnormality flag FL2-T is set to, for example, “0,” On the other hand, when it is determined that a terminal abnormality occurs, that is, when a terminal abnormality is detected, the terminal abnormality flag FL2-T is set to, for example, “1.” The terminal abnormality determination unit 254 outputs the terminal abnormality flag FL2-T.

The transmission information coordinating unit 255 performs the “transmission information coordinating process” that coordinates transmission information to be transmitted to the vehicle 100. More specifically, the transmission information coordinating unit 255 receives the remote operation information OPE and the abnormality flag FL2 (FL2-C, FL2-T). Then, the transmission information coordinating unit 255 coordinates the transmission information according to a content of the abnormality flag FL2.

For example, in the normal state, the transmission information coordinating unit 255 selects the remote operation information OPE as the transmission information and excludes the abnormality flag FL2 from the transmission information (see FIG. 5).

As another example, in the case of the abnormality detection, the transmission information coordinating unit 255 selects the abnormality flag FL2 as the transmission information and excludes the remote operation information OPE from the transmission information (see FIGS. 3 and 4).

The transmission unit 256 transmits the transmission information selected by the transmission information coordinating unit 255 to the vehicle 100.

### 4-3. Example of Terminal Abnormality Determination Process

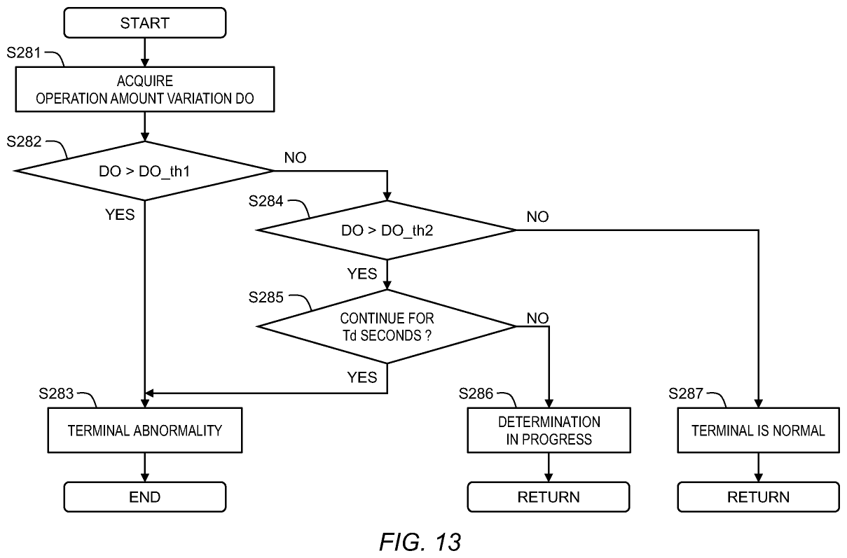

FIG. 13 is a flowchart showing an example of the terminal abnormality determination process performed by the terminal abnormality determination unit 254.

In Step S281, the terminal abnormality determination unit 254 receives the remote operation information OPE. Then, the terminal abnormality determination unit 254 acquires an “operation amount variation DO” that is a variation from a previous value of the operation amount by the remote operator O.

In Step S282, the terminal abnormality determination unit 254 determines whether or not the operation amount variation DO exceeds a first threshold value DO_th1, The first threshold value DO_th1 is an operation amount variation DO where it can be determined that the terminal abnormality occurs. For example, the first threshold value DO_th1 is an operation amount variation DO that cannot normally occur. When the operation amount variation DO exceeds the first threshold value DO_th1 (Step S282; Yes), the processing proceeds to Step S283. On the other hand, when the operation amount variation DO is equal to or less than the first threshold value DO_th1 (Step S282; No), the processing proceeds to Step S284.

In Step S283, the terminal abnormality determination unit 254 determines (asserts) that the terminal abnormality occurs.

In Step S284 the terminal abnormality determination unit 254 determines whether or not the operation amount variation DO exceeds a second threshold value DO_th2. The second threshold value DO_th2 is smaller than the first threshold value DO_th1 described above. For example, the second threshold value DO_th2 is an upper limit value of an allowable range of the operation amount variation DO, When the operation amount variation DO exceeds the second threshold value DO_th2 (Step S284; Yes), the processing proceeds to Step S285. On the other hand, when the operation amount variation DO is equal to or less than the second threshold value DO_th2 (Step S284; No), the processing proceeds to Step S287.

In Step S285, the terminal abnormality determination unit 254 determines whether or not the state in which the operation amount variation DO exceeds the second threshold value DO_th2 continues for Td seconds. When such the state continues for Td seconds (Step S285; Yes), the processing proceeds to Step S283. On the other hand, when such the state has not yet continued for Td seconds (Step S285; No) the processing proceeds to Step S286.

In Step S286, the terminal abnormality determination unit 254 sets the current state to “terminal abnormality determination in progress” without confirming the determination. After that, the processing returns to Step S281.

In Step S287, the terminal abnormality determination unit 254 determines that no terminal abnormality occurs and the remote operator terminal 200 is normal. After that, the processing returns to Step S281.

What is claimed is:

1. A remote operator terminal that communicates with a moving body being a target of a remote operation performed by a remote operator,
the remote operator terminal comprising one or more processors configured to:
perform a communication with the moving body during the remote operation of the moving body;
execute a communication abnormality determination process that determines whether or not an abnormality occurs in the communication with the moving body based on a state of the communication with the moving body;
when it is determined that no abnormality occurs, transmit remote operation information related to the remote operation performed by the remote operator to the moving body; and
when it is determined that the abnormality occurs, transmit information indicating a result of the communication abnormality determination process to the moving body without transmitting the remote operation information to the moving body.

2. The remote operator terminal according to claim 1, wherein
when it is determined that no abnormality occurs, the one or more processors are configured to transmit the remote operation information to the moving body without transmitting the information indicating the result of the communication abnormality determination process to the moving body.

3. A moving body being a target of a remote operation performed by a remote operator,
the moving body comprising one or more processors configured to:
perform a communication with a remote operator terminal on a side of the remote operator during the remote operation of the moving body;
execute a communication abnormality determination process that determines whether or not an abnormality occurs in the communication with the remote operator terminal based on a state of the communication with the remote operator terminal;
when it is determined that no abnormality occurs, transmit moving body information on the moving body to the remote operator terminal; and
when it is determined that the abnormality occurs, transmit information indicating a result of the communication abnormality determination process to the remote operator terminal without transmitting the moving body information to the remote operator terminal.

4. The moving body according to claim 3, wherein
when it is determined that no abnormality occurs, the one or more processors are configured to transmit the moving body information to the remote operator terminal without transmitting the information indicating the result of the communication abnormality determination process to the remote operator terminal.

5. A communication control method of controlling a communication between a moving body being a target of a remote operation performed by a remote operator and a remote operator terminal on a side of the remote operator, the communication control method comprising:
performing a communication between the moving body and the remote operator terminal during the remote operation of the moving body;
a communication abnormality determination process that determines whether or not an abnormality occurs in the communication based on a state of the communication;
when it is determined that no abnormality occurs, transmitting first information from a first device which is one of the moving body and the remote operator terminal to a second device which is another of the moving body and the remote operator terminal; and
when it is determined that the abnormality occurs, transmitting information indicating a result of the communication abnormality determination process from the first device to the second device without transmitting the first information.

6. The communication control method according to claim 5, wherein
when it is determined that no abnormality occurs, transmitting the first information from the first device to the second device without transmitting the information indicating the result of the communication abnormality determination process.
